(19) United States
(12) Patent Application Publication
(10) Pub. No.: US 2026/0316461 A1
(43) Pub. Date: Oct. 15, 2026

(54) Method and Device for Preventing Typographical Errors During Digital Printing Due to Faulty Printing Nozzles

(71) Applicant: SWISS KRONO Tec AG, Luzern (CH)

(72) Inventor: Sebastian Dicke, Bantikow (DE)

(21) Appl. No.: 19/482,892

(22) PCT Filed: May 8, 2024
(86) PCT No.: PCT/EP2024/062731

§ 371 Date: Nov. 10, 2025

(30) Foreign Application Priority Data
May 11, 2023 (EP) 23172734.8

(51) Int. Cl. B41J 2/21; B41J 2/045; B41J 29/393; G06K 15/00

(52) U.S. Cl. CPC B41J 2/2142; B41J 2/0457; B41J 2/04581; B41J 2/2135; B41J 2/2139; B41J 29/393; G06K 15/408

(57) ABSTRACT

The disclosure relates to a method for preventing typographical errors during digital printing due to faulty printing nozzles including a digital printer, the method including the steps: i. monitoring at least one printing nozzle of the digital printer and measuring the printing performance of the at least one printing nozzle and of each further monitored printing nozzle; ii. specifying a target value and a tolerance value for the printing performance of each monitored printing nozzle of the digital printer; iii. calculating and storing the deviation of the printing performance of at least one monitored printing nozzle from the target value of this printing nozzle; i. correcting the printing performance of at least one printing nozzle when the deviation of the printing performance of at least one monitored printing nozzle is greater than the tolerance value, wherein the printing performance of at least one printing nozzle is corrected by a. correcting the separation data; and/or b. controlling the voltage of the printing nozzle, the printing performance of which is below the tolerance value; and/or c. changing the print angle of at least one adjacent printing nozzle.

### CROSS-REFERENCE TO RELATED APPLICATIONS

This application is the United States national phase of International Patent Application No. PCT/EP2024/062731 filed May 8, 2024, and claims priority to European Patent Application No. 23172734.8 filed May 11, 2023, the disclosures of which are hereby incorporated by reference in their entireties.

### BACKGROUND

### Technical Field

The disclosure relates to a method for preventing typographical errors during digital printing due to faulty printing nozzles comprising a digital printer, wherein the method comprises the steps:
i. monitoring at least one printing nozzle of the digital printer and measuring the printing performance of the at least one printing nozzle and of each further monitored printing nozzle;
ii. specifying a target value and a tolerance value for the printing performance of each monitored printing nozzle of the digital printer;
iii. calculating and storing the deviation of the printing performance of at least one monitored printing nozzle from the target value of this printing nozzle;
iv. correcting the printing performance of at least one printing nozzle when the deviation of the printing performance of at least one monitored printing nozzle is greater than the tolerance value.

The disclosure also relates to a device for preventing typographical errors during digital printing due to faulty printing nozzles, and to a method for printing a printed pattern onto a substrate using a digital printer.

### Technical Considerations

There are a variety of technical solutions for reproducing or duplicating print patterns. The term “printing technology” encompasses all methods for reproducing print patterns, such as letterpress printing, offset printing, gravure printing, flexographic printing, screen printing and digital printing. These printing techniques use different methods to transfer a printing medium, such as an ink, to a printing substrate. Each printing technique offers different advantages and is used in different areas of application.

The areas of application of printing technology are highly diverse. It is known, for example, to print print media, wallpapers or the like. For example, so-called decorative printing is used in the manufacture of flooring laminate or wall and ceiling cladding elements. Here, wood-based panels are often printed on. There is a plurality of approaches for decorating wood-based panels. In the past, wood-based panels were often coated with decorative paper, with no limits to the variety of differently patterned decorative papers available. As an alternative to the use of decorative papers on wood-based panels, the possibility of direct printing on wood-based panels has been developed, eliminating the need for printing on paper and subsequently laminating or directly coating it onto the wood-based panels. Here, the main printing techniques used here are gravure and digital printing methods. For the use of these printing methods, the printed pattern is available as a digital template that depicts the colors and color distribution of the printed pattern. At the beginning of the printing process, a separation file is created, in which the print pattern is broken down into the basic colors to be printed.

During digital printing, the print pattern is transferred directly from a computer to a digital printer, such as a laser printer or inkjet printer. In digital printing, the use of static printing forms is therefore eliminated, as are the limitations in the print data length and print data width of the print patterns. Thus, digital printing offers a high degree of flexibility and variability in terms of printed motifs and does not entail any restrictions in the pattern repeat.

From the prior art, digital printing is also known for printing wood-based panels. EP 2 181 852 B1, for example, relates to a digital printing method for printing flat wood-based panels. Here, the flat plates are printed directly with a digital printer.

In digital printing, the primary colors cyan, magenta, yellow and black (CMYK) are usually used. The CMYK color model is a subtractive color model, wherein the abbreviation CMYK stands for the three color components cyan, magenta, yellow, and the black component key as the color depth. This color system can be used to represent a color space (gamut) that meets many requirements from a wide variety of areas. During digital printing, the printing medium is applied droplet by droplet to the printing substrate. For this purpose, the printing head comprises a large number of printing nozzles, wherein each printing nozzle is able to dispense a printing medium droplet by droplet.

So-called piezo nozzles are known in the prior art, in which the printing medium is shot out of the printing nozzle by pressure (US 2005/0063016 A1). The pressure is built up by a piezo element. In piezoelectric materials, pressure causes charges to be created on the surfaces of the material. Conversely, in these materials the inverse piezoelectric effect causes a change in length when an electrical voltage is applied. This actuator effect converts electrical energy into mechanical energy and is used in so-called piezo actuators. Piezo actuators known from the prior art make possible travel distances ranging from a few tens of 10 μm up to several millimeters, depending on their design. For example, longitudinal actuators, shear actuators, tubular actuators, contracting actuators and bending actuators are known to a person skilled in the art. While longitudinal actuators can achieve travel distances in the range of a few 10 μm to a few 100 μm, bending actuators are characterized by travel distances of up to a few millimeters.

In printing nozzles of printing heads, a voltage is applied to the piezo actuator, causing it to deform and, in the process, the wall of a channel for the printing medium in the printing nozzle is likewise deformed. As a result, the volume of the channel changes, by which a droplet of the printing medium of a desired size is ejected from the printing nozzle. A so-called “waveform” is used for controlling the printing nozzle. The “waveform” describes the voltage curve that is applied to a piezo actuator over time and thus causes its deformation.

When leaving the printing head nozzle, the droplet typically forms a ligament, which is ideally drawn back into the droplet. However, it also occurs that the ligament atomizes and forms a fine mist. This fine mist contaminates the nozzles of the printing head and other elements of the printing device. Over time, this diminishes the print quality, and cleaning the printer is necessary.

Another problem is the condensation of water vapor on the printing head, which can impair print quality or even damage the printing head.

The functionality of the printing nozzles can also be limited by paper dust, air bubbles or the drying out of ink. Furthermore, due to their technical design, digital printers are often susceptible to disruptions at the printing heads. If a printing head fails, this is immediately recognizable as streaking in the printed image on the printing substrate.

Although digital printing can be used very advantageously in many areas, the quality of the printed image depends on the faultless functioning of the printing heads and, in particular, the printing nozzles.

EP 3 691 904 B1, for example, is known from the prior art and deals with a wood simulation method. The subject matter of the patent specification is a method intended to prevent individual nozzles of printing heads from becoming clogged by dust or the effects of heat. In the process, the performance of the individual nozzles of the printing heads is monitored by monitoring the printed pattern. Here, each printed pixel is assigned to one or more nozzles, allowing a conclusion to be drawn as to which nozzles have not printed for what period of time. If the time T1 in which a nozzle was inactive exceeds a specified limit value, this nozzle is designated for “cleaning”.

The “cleaning” of the nozzles recognized as inactive, and optionally also of adjacent nozzles, is carried out by printing a “mask”. In the process, smaller droplet sizes are deliberately printed into knot structures, pore structures or the like of the pattern (“mask”) in order to clean the inactive nozzles and prevent clogging. The printed “mask” is not intended to be visually noticeable in the printed image and is not intended to compensate for or correct typographical errors, but only to clean printing nozzles.

However, EP 3 691 901 B1 only makes possible the detection of inactive printing nozzles based on quality defects in the printed image. During subsequent printing, further quality defects can be avoided by cleaning the printing nozzle, but the patterns already printed are usually rejects. In addition, downtime of the printing system occurs when printing nozzles have to be cleaned.

EP 3 656 571 A1 deals with the compensation of typographical errors in a printed pattern during printing. The monitoring of the nozzles is described in such a way that, based on a previous print of a pattern or a reference print, faulty areas in the print are detected. According to EP 3 656 571 A1, corrections are then provided for the subsequent printing. In the process, the droplet sizes of individual nozzles or adjacent nozzles are adjusted. However, even in this method, it is only possible to react to a pattern or reference that has already been printed incorrectly. This is time-consuming and costly, because rejects cannot be avoided.

US 2022/0161551 A1 relates to a printing device in which piezoelectric printing nozzles are monitored. After ink droplets are ejected from a printing nozzle, the piezo element of the particular printing nozzle oscillates. This oscillation is monitored for intensity and frequency, and conclusions about a malfunction of the printing nozzle are derived from the signals by comparing them with reference values. If a malfunction of a printing nozzle is detected, it can be compensated for by adjusting adjacent printing nozzles (complementary printing), or the faulty nozzle can be cleaned (ejection operation). According to US 2022/0161551 A1, a reaction to malfunctioning printing nozzles is only possible to a very limited extent. If the faulty printing performance of a printing nozzle cannot be compensated for in this way, the printing device must be serviced or repaired, which leads to interruptions in the printing process and thus to economic losses.

US 2007/0103500 A1 also relates to a method for preventing typographical errors during digital printing due to faulty printing nozzles. The printing nozzles are monitored by measuring pressure by means of a pressure sensor. In each case, a pressure sensor is arranged in a pressure chamber, wherein the pressure chamber comprises a piezo actuator. The measured values of the pressure sensor are compared with a target value. Deviations from this target value are evaluated and maintenance instructions are provided. Suitable maintenance processes can include, for example, vacuuming or rinsing the nozzles. However, error correction without interrupting the ongoing printing process is not provided.

It is therefore the object of the disclosure to provide a method in which the print quality can be kept constantly high and thus the economic efficiency of printing methods can be increased.

For this purpose, the disclosure provides a method described herein.

### SUMMARY

The disclosure provides a method in which rejects or prints with quality defects due to malfunctioning printing nozzles are avoided by avoiding prints with quality defects due to malfunctioning printing nozzles.

The method for preventing typographical errors during digital printing due to faulty printing nozzles comprises a digital printer.

The digital printer comprises at least one printing head with at least one printing nozzle, wherein the printing nozzle comprises a piezo actuator. Digital printers with piezo nozzles are well known to experts. Generally, a printing head comprises more than one printing nozzle. Commercially available printing heads can, for example, comprise 1200 printing nozzles per inch.

According to the disclosure, at least one printing nozzle of the digital printer is monitored and its printing performance is captured. If a plurality of printing nozzles are monitored, the printing performance of each of the monitored printing nozzles is captured.

In one non-limiting embodiment of the method according to the disclosure, between 20% and 100%, preferably between 50% and 100% of the printing nozzles of the digital printer are monitored.

In one non-limiting embodiment of the present disclosure, at least one printing nozzle is monitored by
monitoring the expansion of the piezo actuators of the printing nozzle, and/or
monitoring the voltage applied to the piezo actuator of the printing nozzle.

The expansion of the piezo actuators can be carried out, for example, by monitoring the pressure in the channel for the printing medium adjacent to the piezo actuator. However, so-called “piezo self-sensing signals” are also known from the prior art, which can be used to monitor the expansion of the piezo actuators.

Additionally or alternatively, the printing nozzle can also be monitored via the voltage applied to the piezo actuator.

The data obtained when monitoring the at least one printing nozzle is sent to a computer unit, hereinafter also referred to as the computer, with suitable software. Through the software, a printing performance of the monitored printing nozzle can be ascertained.

Due to the monitoring of a printing nozzle, it is possible to determine how a printing nozzle is working or whether it is working at all (printing performance equals zero). The printing performance of the monitored printing nozzle can be determined on a predefined scale that is integrated into the software. Such a scale can be determined, for example, through reference measurements and is then stored in the software.

Monitoring the printing nozzles by monitoring the piezo actuators has the great advantage that malfunctions of the piezo actuators and thus the printing nozzles can be detected during printing. As a result, direct intervention in the printing process can be carried out and a correction performed in order to maintain the print quality.

A particular advantage compared to the prior art is that defective areas in the printed image due to malfunctioning printing nozzles are not detected first, but rather such defective areas are largely avoided through corrections performed. As a result, rejects caused by printing with faulty printing nozzles can be minimized or even avoided altogether. Thus, the print quality can be maintained consistently throughout the entire printing process.

In one non-limiting embodiment, in addition to monitoring the at least one printing nozzle, the printed image printed by the digital printer can also be optically monitored. Such monitoring can be carried out, for example, by a digital camera or a spectral camera or a hyperspectral camera.

The spectral camera, for example, is a multispectral camera with 12 image channels per captured pixel, which generates one pixel per image channel. This creates a color spectrum of 12 image channels for each captured pixel. A common sensor technology provides individual pixels on a CMOS sensor with different color filters, so that a variety of spectral information can be recorded from a captured image with one image capture.

In the hyperspectral camera, the light is spectrally split for each pixel by means of an optical device, for example a prism, and the individual spectral ranges are measured separately. As a result, the spectral resolution increases compared with a multispectral camera to approximately 20 to 250 or more image channels.

In contrast to a conventional RGB camera, not just one color but rather a spectral distribution with significantly greater information depth is obtained for each pixel.

Through optical monitoring, the quality of the printed image can additionally be checked. The images captured by the optical monitoring system are sent to a computer unit where they are evaluated using suitable software.

In one non-limiting embodiment, AI software can additionally be used to perform trend recognition of print quality and/or prediction of the development of print quality. The result of the trend recognition and/or prediction by the AI software can be taken into account when ascertaining the printing performance of the printing nozzles, for example by taking possible results of the AI software into account when creating the predefined scale already described.

In a further non-limiting embodiment of the present disclosure, the results of the AI software can be used to examine the ascertained printing performance of the printing nozzles. If the results of the AI software deviate from at least one ascertained printing performance, a warning message can be issued to a user. As a result, a further quality control can be performed.

In a further non-limiting embodiment, a comparison can be carried out with a reference image stored in the software in order to be able to detect defective areas. If defective areas are detected, a warning message can be issued to a user and/or further corrections can be made to the printing performance of at least one printing nozzle according to the present disclosure.

### DETAILED DESCRIPTION

According to the disclosure, a target value and a tolerance range are specified for each monitored printing nozzle. The target value defines the full functionality of the printing nozzle, and the tolerance value indicates by how many percent the target value may be exceeded or undershot.

In one non-limiting embodiment, the tolerance value is between 1% and 70%, preferably between 1% and 65%, more preferably between 1% and 60%. This makes it possible to account for changes in the performance of a printing nozzle of between 1% and 70%. By setting the tolerance value, the requirements for the quality of a printed image can be controlled. The smaller the tolerance value, the smaller the tolerated changes in the performance of a printing nozzle and the higher the print quality of the printed image.

According to the disclosure, the deviation of the measured printing performance of at least one printing nozzle from the target value is calculated and subsequently stored. The deviation is compared with the tolerance value, and if the deviation is greater than the specified tolerance range, a correction of the printing performance of at least one printing nozzle is performed.

In one non-limiting embodiment, the deviation of the printing performance from the particular target value is determined for each monitored printing nozzle.

According to the disclosure, the correction of the printing performance can, but does not have to, take place at the printing nozzle whose printing performance has fallen below the tolerance value. In one non-limiting embodiment, this makes it possible for printing nozzles adjacent to the malfunctioning printing nozzle to be corrected, thereby preventing a loss of quality in the printed image.

In one non-limiting embodiment of the present disclosure, a correction of the printing performance of a printing nozzle is carried out by a correction of at least one printing nozzle of the digital printer and/or by a correction of the separation data.

According to the disclosure, corrections to at least one printing nozzle can be carried out by
correcting the separation data; and/or
controlling the voltage of the printing nozzle, the printing performance of which is below the tolerance value; and/or
controlling the voltage of the printing nozzles adjacent to the printing nozzle, the printing performance of which is below the tolerance value; and/or
changing the print angle of at least one adjacent printing nozzle.

In the process, a correction to a printing nozzle of the digital printer can be carried out by
controlling the voltage of the printing nozzle, the printing performance of which is below the tolerance value; and/or
controlling the voltage of the printing nozzles adjacent to the printing nozzle, the printing performance of which is below the tolerance value; and/or
changing the print angle of at least one adjacent printing nozzle.

In particular, the correction of the printing performance of the at least one printing nozzle, the deviation of the printing performance of which is greater than the tolerance value, is carried out by
correcting the separation data, wherein the black/white pixels for the at least one printing nozzle, the deviation of the printing performance of which is greater than the tolerance value, are adjusted; and/or
controlling the voltage of the printing nozzle, the deviation of the printing performance of which is greater than the tolerance value; and/or
changing the print angle of at least one printing nozzle adjacent to the printing nozzle, the deviation in printing performance of which is greater than the tolerance value.

In one non-limiting embodiment, the computing unit sends a signal to the affected faulty printing nozzle itself and/or to a printing nozzle or printing nozzles adjacent to it to compensate for the state value of the faulty nozzle by commanding a changed droplet size. In the process, the droplet size is controlled by the voltage and thus by the waveform applied to the piezo actuator of a printing nozzle. Typical droplet sizes range from 1 to 8 picoliters.

In the process, adjacent printing nozzles are preferably arranged next to the faulty printing nozzle in the direction of the print width. All conceivable combinations are possible. This means that the printing performance of the faulty printing nozzle alone, only the printing performance of an adjacent printing nozzle or adjacent printing nozzles, or also the printing performance of the faulty printing nozzle and the printing performance of an adjacent printing nozzle or adjacent printing nozzles can be adjusted.

The printing nozzle detected as defective can also be switched off and completely compensated for by the adjacent printing nozzle or the adjacent printing nozzles.

Due to the increased ink application of the faulty printing nozzle and/or by compensating for the ink application by one or more adjacent printing nozzles, a printing nozzle failure does not become visible in the printed image at all. As a result, no defective areas are visible in the printed image.

In a further non-limiting embodiment, printing nozzles adjacent to the faulty printing nozzle print at an angle in the direction of the faulty printing nozzle. In particular, the print angle of at least one printing nozzle adjacent to the faulty printing nozzle is adjusted or two printing nozzles adjacent to the faulty printing nozzle are adjusted. The angle of the adjacent printing nozzles must be selected in the process so that the droplet lands in the middle position and thus covers at least parts of the printing regions of both printing nozzles. In this way, the droplet practically covers parts of its own printing region along with the printing region of the faulty printing nozzle.

In one non-limiting embodiment, the print angle of the at least one adjacent printing nozzle is adjusted as already described and, in addition, its printing performance is performed by adjusting the separation data and/or by adjusting the voltage. If necessary, the ink application (in the form of droplet size) of the at least one adjacent printing nozzle can be increased in order to make an optimal correction possible.

In a further non-limiting embodiment, the printing performance of a printing nozzle is corrected by correcting the separation data.

The faulty printing nozzle is then compensated for by adjusting the separation data of the individual color rows/printing head rows, by which a defective printing nozzle is compensated for by data adjustment in the print file and/or adjacent printing nozzles of the faulty printing nozzle also take over this region.

By means of software, the digital separation data are adjusted by providing the region(s) of the adjacent printing nozzle(s) with printing information in order to compensate for the performance drop or even failure of the faulty printing nozzle. Furthermore, the separation data can also be adjusted so that the faulty printing nozzle prints with greater intensity. A combination is also possible.

The separations contain black/white pixels for each printed image, which are passed on to the printing nozzles. White means no printing takes place, 100% black means the largest droplet is printed. In this way, the droplet size in printing is controlled by the black tone value. For example, with white no printing takes place, up to 30% black droplet 1 (small) is printed, up to 60% black droplet 2 (medium), and above that droplet 3 (large).

In the printed image and the separation file, depending on the resolution in the print width, a certain region is always assigned to a printing nozzle in the printing direction. Thus, in the event of a faulty printing nozzle, the separation file for this narrow region of the nozzle can be adjusted by means of software. For example, the intensity for a region can be increased by a certain amount or the line can be deleted and the printing nozzle can be switched off. At the same time, the adjacent printing nozzles can print more to compensate for the switched-off printing nozzle.

Furthermore, it is possible that over time, printing nozzles that print with an excessive intensity may have their droplet size reduced by the computing unit, or the separation data may be adjusted by reducing printing information in order to print smaller droplets. That is, the droplet size is adjusted either by the voltage at the piezo actuator, i.e. via the waveform, and/or via the separation data, i.e. via the value of the black/white pixels. Both approaches have already been described.

In one non-limiting embodiment, the separation data are adjusted during the ongoing printing process. This has the advantage that the printing process does not have to be interrupted, thus increasing the economic efficiency of the printing process.

In one non-limiting embodiment, a correction takes place by changing both the separation data and the voltage of at least one printing nozzle.

The extent to which a change in the voltage of a printing nozzle and/or separation data must be performed in order to achieve a certain change can be specified, for example, by correction data sets. Such data sets can be created in advance under faultless printing conditions (all printing nozzles are functioning properly) and indicate the impact a certain correction has on the print result.

The present disclosure thus advantageously provides numerous ways to prevent faulty printing caused by one or more malfunctioning printing nozzles of a digital printer during the ongoing printing process. The method according to the disclosure can enormously increase the economic efficiency of such printing processes, since printer downtimes and the production of misprints can be significantly reduced.

Furthermore, the disclosure provides a device for preventing typographical errors during digital printing due to faulty printing nozzles, wherein the device is designed to perform the method according to the disclosure. The device comprises
a digital printer;
a computing unit; and
at least one means for monitoring the printing performance of at least one printing nozzle of the digital printer.

The device comprises at least one computing unit on which the data from the monitoring of the at least one printing nozzle are collected and on which the deviation of the printing performance from the target value is calculated. Furthermore, the deviation is compared with the tolerance value on the computing unit and a correction is triggered according to the method according to the disclosure. For this purpose, the computing unit controls
the voltage of the piezo actuators of the printing nozzles of a digital printer; and/or
the print angle of at least one printing nozzle.

Furthermore, in one non-limiting embodiment, the separation data can be adjusted using the computing unit.

The device comprises at least one means for monitoring the printing performance of at least one printing nozzle. This can, for example, be a suitable pressure sensor in the channel of the printing medium or other suitable sensors in order to monitor the expansion of the piezo actuators and/or their voltage. The means for monitoring the printing performance of at least one printing nozzle is connected to the at least one computing unit in order to forward the detected signals to the computing unit.

In one non-limiting embodiment, the device further comprises at least one means for optically monitoring the printed image of the digital printer. This can be, for example, a digital camera, a spectral camera or a hyperspectral camera. The digital camera, spectral camera or hyperspectral camera is preferably connected to the at least one computing unit.

Furthermore, the disclosure provides a method for printing a printed pattern onto a substrate using a digital printer. In the method
at least one printing nozzle of the digital printer is monitored using a method according to the disclosure, while the digital printer is printing a printed pattern onto a substrate.

In one non-limiting embodiment of the disclosure, all printing nozzles of the digital printer are monitored using a method according to the disclosure.

In a further non-limiting embodiment of the disclosure, the substrate is selected from the group comprising paper, glass, metal, films, wood-based materials, in particular MDF or HDF boards, WPC boards, veneers, lacquer layers, plastic panels, fiber-reinforced plastic, hardboard, and inorganic carrier panels.

The features described for the method according to the disclosure apply in the same way to the device according to the disclosure, and vice versa.

With the present disclosure, failures or performance losses of individual printing nozzles can advantageously be recognized and corrected at an early stage, thus avoiding defective areas in the printed image. This allows intervention in the printing process at an earlier stage than with methods under the prior art, thereby maintaining high print quality. The disclosure thus provides a way to monitor printing processes preventively, such that faulty nozzles are recognized at an early stage and their impact on the printed image is remedied already during the printing process. In addition, the economic efficiency of printing processes is increased, since rejects can be minimized. Manufacturers of printed products thereby save costs through reduced scrap and less downtime, and record fewer complaints that have slipped through quality control. The present disclosure makes it possible to minimize downtimes of printing systems that would otherwise be required for cleaning printing nozzles.

In the following, the disclosure is explained in more detail using three exemplary non-limiting embodiments.

### Exemplary Non-limiting Embodiment 1—Performance Drop of a Printing Nozzle in Digital Paper Printing

At a manufacturer of laminate floorboards, patterns for further processing into decorative panels were printed onto paper rolls using a digital paper printing system.

The print width or roll width was 2060 mm and the resolution of the printing heads was 1200 dpi. There were 97,322 printing nozzles available in the print width (2060 mm: 25.4 mm×1200 dpi). The printing intensity of the printing nozzles of the printing heads used could be individually adjusted electrically by means of a computing unit. That is, the voltage of each printing nozzle could be controlled individually by setting the waveform. In addition, the individual printing nozzles were monitored and the data were captured by means of the computing unit, the deviation from the target value was calculated and this deviation was compared with a tolerance value.

A tolerance value of 20% was set.

During production, the monitoring of the printing nozzle 1.112 first captured a performance drop of 17%. Since the tolerance value has not yet been exceeded, the printing nozzle was kept under observation, but no further action has been taken. A few minutes later, the nozzle suddenly lost a further 20% of its performance, resulting in a total loss of 37%. The tolerance value was thus exceeded and the printing nozzle received a higher voltage by means of the computing unit by changing the waveform. The readjustment resulted in the printing of a larger droplet, which was sufficient to compensate for the defect. Without correction, a light stripe would have appeared in the printed image.

The print production of the paper roll could be used directly for further processing without errors or rewinding. The manufacturer saved costs through reduced scrap, less downtime and fewer complaints that have slipped through quality control.

### Exemplary Non-limiting Embodiment 2—Failure of a Printing Nozzle in Digital Paper Printing

At a manufacturer of laminate floorboards, patterns for further processing into decorative panels were printed onto paper rolls using a digital paper printing system.

The print width or roll width is 2060 mm and the resolution of the printing heads was 1200 dpi. There were 97,322 printing nozzles available in the print width (2060 mm: 25.4 mm×1200 dpi). The printing intensity of the printing nozzles of the printing heads used could be individually adjusted electrically by means of a computing unit. In addition, the individual printing nozzles were monitored and the data were captured by means of the computing unit, the deviation from the target value was calculated and this deviation was compared with a tolerance value.

A tolerance value of 60% was set.

During production, the monitoring of the printing nozzle 1.112 captured a performance drop of 63%. The printing nozzle had already been continuously deteriorating in performance and the loss in the printed image was compensated for by the adjacent printing nozzle(s). The tolerance for the complete switching off of the printing nozzle was set to 60% and the printing nozzle was switched off. At the same time, the two nozzles 1.111 and 1.113 were in each case immediately assigned 50% larger droplets for the ongoing printing process, in equal parts and without stopping production. The adjacent nozzles compensated for the defect caused by the switched-off printing nozzle. Without this compensation, a light stripe would have appeared in the printed image.

The print production of the paper roll could be used directly for further processing without errors or rewinding. The manufacturer saved costs through reduced scrap, less downtime and fewer complaints that have slipped through quality control.

### Exemplary Non-Limiting Embodiment 3—Performance Drop of a Printing Nozzle in Digital Paper Printing (Separation Data)

At a manufacturer of laminate floorboards, patterns for further processing into decorative panels were printed onto paper rolls using a digital paper printing system.

The print width or roll width was 2060 mm and the resolution of the printing heads was 1200 dpi. There were 97,322 printing nozzles available in the print width (2060 mm: 25.4 mm×1200 dpi). The printing intensity of the printing nozzles of the printing heads used could be individually adjusted electrically by means of a computing unit. In addition, the individual printing nozzles were monitored and the data were captured by means of the computing unit, the deviation from the target value was calculated and this deviation was compared with a tolerance value.

A tolerance value of 30% was set.

During production, the monitoring of the printing nozzle 1.112 first captured a performance drop of 20%. Since the tolerance value has not yet been exceeded, the printing nozzle was kept under observation, but no further action has been taken. A few minutes later, the nozzle suddenly lost a further 20% of its performance, resulting in a total loss of 40%. The tolerance value was thus exceeded and the separation data were adjusted, so that the faulty printing nozzle printed with correspondingly greater intensity. As a result, the previously detected performance drop could be compensated for.

The print production of the paper roll could be used directly for further processing without errors or rewinding. The manufacturer saved costs through reduced scrap, less downtime and fewer complaints that have slipped through quality control.

### Exemplary Non-Limiting Embodiment 4—Performance Drop of a Printing Nozzle in Digital Paper Printing (change in Print Angle of Adjacent Printing Nozzles)

At a manufacturer of laminate floorboards, patterns for further processing into decorative panels were printed onto paper rolls using a digital paper printing system.

The print width or roll width was 2060 mm and the resolution of the printing heads was 1200 dpi. There were 97,322 printing nozzles available in the print width (2060 mm: 25.4 mm×1200 dpi). The printing intensity of the printing nozzles of the printing heads used could be individually adjusted electrically by means of a computing unit. That is, the voltage of each printing nozzle could be controlled individually by setting the waveform. In addition, the print angle of the individual printing nozzles could be changed. In addition, the individual printing nozzles were monitored and the data were captured by means of the computing unit, the deviation from the target value was calculated and this deviation was compared with a tolerance value.

A tolerance value of 25% was set.

During production, the monitoring of the printing nozzle 1.100 captured a performance drop of 30%. Since the tolerance value was exceeded, the print angle of the adjacent printing nozzles 1.099 and 1.101 was changed in such a way that the printing region of the printing nozzle 1.100 was at least partially covered by the printing nozzles 1.099 and 1.101. Due to the correction, a faultless printed image could be ensured. Without correction, a light stripe would have appeared in the printed image.

The print production of the paper roll could be used directly for further processing without errors or rewinding. The manufacturer saved costs through reduced scrap, less downtime and fewer complaints that have slipped through quality control.

1. A method for preventing typographical errors during digital printing due to faulty printing nozzles comprising a digital printer, comprising:
i. monitoring at least one printing nozzle of the digital printer and measuring the printing performance of the at least one printing nozzle and of each further monitored printing nozzle;
ii. specifying a target value and a tolerance value for the printing performance of each monitored printing nozzle of the digital printer;
iii. calculating and storing the deviation of the printing performance of at least one monitored printing nozzle from the target value of this printing nozzle; and
iv. correcting the printing performance of at least one printing nozzle when the deviation of the printing performance of at least one monitored printing nozzle is greater than the tolerance value, wherein the printing performance of at least one printing nozzle is corrected by at least one of the following:
a. correcting the separation data; wherein the separation data contain black/white pixels and use them to define the droplet size;
b. controlling the voltage of the printing nozzle, the printing performance of which is below the tolerance value;
c. changing the print angle of at least one adjacent printing nozzle.
or any combination thereof.

2. The method according to claim 1, wherein between 20% and 100% of the printing nozzles of the digital printer are monitored.

3. The method according to claim 1, wherein in method step iii, the deviation of the printing performance from the particular target value is determined for each monitored printing nozzle.

4. The method according to claim 1, wherein the at least one printing nozzle is monitored by at least one of the following:
monitoring the expansion of the piezo actuators of the printing nozzle,
monitoring the voltage applied to the piezo actuator of the printing nozzle,
or any combination thereof.

5. The method according to claim 4, wherein the printed image printed by the digital printer is further optically monitored.

6. The method according to claim 1, wherein the tolerance value is between 1% and 70%.

7. The method according to claim 1, wherein a correction of the printing performance in method step iv. is carried out by a correction of at least one printing nozzle of the digital printer and/or by a correction of the separation data.

8. The method according to claim 1, wherein a correction is further carried out on at least one printing nozzle by controlling the voltage of printing nozzles that are adjacent to the printing nozzle, the printing performance of which is below the tolerance value.

9. A device for preventing typographical errors during digital printing due to faulty printing nozzles, configured to perform a method according to one-of claim 1, comprising
a digital printer;
a computing unit; and
at least one means for monitoring the printing performance of at least one printing nozzle of the digital printer.

10. The device according to claim 9, wherein the device further comprises at least one means for optically monitoring the printed image of the digital printer.

11. The device according to claim 10, wherein the at least one means for optically monitoring the printed image of the digital printer is at least one of the following: a digital camera, a spectral camera, a hyperspectral camera, or any combination thereof.

12. A method for printing a printed pattern onto a substrate using a digital printer, wherein
at least one printing nozzle of the digital printer is monitored using a method according to claim 1, while the digital printer is printing a printed pattern onto a substrate.

13. The method according to claim 12, wherein all printing nozzles of the digital printer are monitored
i. monitoring at least one printing nozzle of the digital printer and measuring the printing performance of the at least one printing nozzle and of each further monitored printing nozzle;
ii. specifying a target value and a tolerance value for the printing performance of each monitored printing nozzle of the digital printer;
iii. calculating and storing the deviation of the printing performance of at least one monitored printing nozzle from the target value of this printing nozzle; and
iv. correcting the printing performance of at least one printing nozzle when the deviation of the printing performance of at least one monitored printing nozzle is greater than the tolerance value, wherein the printing performance of at least one printing nozzle is corrected by at least one of the following:
a. correcting the separation data; wherein the separation data contain black/white pixels and use them to define the droplet size;
b. controlling the voltage of the printing nozzle the printing performance of which is below the tolerance value;
c. changing the print angle of at least one adjacent printing nozzle. or any combination thereof.

14. The method according to claim 12, wherein the substrate is selected from the group comprising paper, glass, metal, foils, wood-based panels, in particular MDF or HDF panels, WPC panels, veneers, lacquer layers, plastic panels, fiber-reinforced plastic, hardboard and inorganic carrier panels.

15. The method according to claim 1, wherein between 50% and 100% of the printing nozzles of the digital printer are monitored.

16. The method according to claim 1, wherein the tolerance value is between 1% and 65%.

17. The method according to claim 1, wherein the tolerance value is between 1% and 60%.
